(19) United States
(12) Patent Application Publication
(10) Pub. No.: US 2026/0179054 A1
(43) Pub. Date: Jun. 25, 2026

(54) SYSTEMS AND METHODS FOR IDENTIFYING FAULTY VEHICLE TRACKING UNITS

(71) Applicant: Verizon Patent and Licensing Inc., Basking Ridge, NJ (US)

(72) Inventors: Bernardo MONECHI, Firenze (IT); Marco BOSCHI, Ravenna (IT); Leonardo SARTI, Florence (IT)

(73) Assignee: Verizon Patent and Licensing Inc., Basking Ridge, NJ (US)

(21) Appl. No.: 18/999,505

(22) Filed: Dec. 23, 2024

(51) Int. Cl. G06Q 10/20; G06Q 50/40; G07C 5/08; G08G 1/00

(52) U.S. Cl. CPC G06Q 10/20; G06Q 50/40; G07C 5/0808; G08G 1/202

(57) ABSTRACT

A device may receive TU data associated with TUs, and may identify a problematic TU from the TU data. The device may extract TU messages from the TU data associated with the problematic TU, and may calculate a faulty event score, a faulty location score, a faulty battery score, a faulty alerts score, a faulty other score, and a heartbeat score based on the TU messages. The device may calculate a faulty TU score for the problematic TU based on the faulty event score, the faulty location score, the faulty battery score, the faulty alerts score, the faulty other score, and the heartbeat score, and may aggregate the TU messages into aggregated TU messages. The device may process the aggregated TU messages, with an LLM, to determine a problem with the problematic TU and an explanation of the problem, and may perform actions based on the problem and the explanation.

### BACKGROUND

In fleet management and vehicle tracking, vehicle tracking units (VTUs) may continuously transmit various types of messages that inform about statuses of vehicles and the VTUs associated with the vehicles.

### BRIEF DESCRIPTION OF THE DRAWINGS

FIGS. 1A-1H are diagrams of an example associated with identifying faulty VTUs.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for identifying faulty VTUs.

### DETAILED DESCRIPTION OF EXAMPLE EMBODIMENTS

The following detailed description of example implementations refers to the accompanying drawings. The same reference numbers in different drawings may identify the same or similar elements.

Messages generated by a VTU may include heartbeat signals to confirm VTU functionality, location (e.g., global positioning system (GPS)) updates, engine status, and alerts regarding vehicle conditions (e.g., temperature and tire pressure) and VTU conditions (e.g., Wi-Fi or GPS module issues). The uninterrupted and accurate transmission of VTU messages may enable effective monitoring and management of vehicle fleets. However, problems can arise when VTUs cease to report or produce unusual message patterns that deviate from expected behavior. For example, VTUs failing to report heartbeat messages or other critical information may indicate VTU malfunctions or other operational issues. The cessation of VTU communication or an anomaly in transmission can result from a variety of root causes, such as hardware failures, software glitches, or connectivity issues associated with the VTU. Detecting these anomalies in real-time may maintain the integrity of fleet management systems. However, identifying and diagnosing the root cause of such anomalies is challenging. Current methods may rely heavily on manual review or simplistic rule-based systems that can result in delayed detection, misdiagnosis, or an inability to pinpoint an underlying issue. Furthermore, the current processes for identifying and addressing VTU issues may be resource-intensive and may not scale well with an increasing number of VTUs and a complexity of fleet operations. Similarly, any system and/or device that fails to report a heartbeat or other critical information may indicate deviation from expected behavior and detection of these anomalies present similar challenges.

Thus, current techniques for identifying faulty VTUs of vehicles consume computing resources (e.g., processing resources, memory resources, communication resources, and/or the like), networking resources, and/or other resources associated with failing to accurately identify problematic VTUs in real time, failing to generate alerts for the problematic VTUs, generating incorrect fleet management information based on incorrect information received from the problematic VTUs, failing to provide proper vehicle tracking for vehicles associated with the problematic VTUs, and/or the like.

Some implementations described herein relate to an anomaly detection system that identifies faulty VTUs or other similar devices such as Internet of Things (IoT) devices, asset tracking units, fleet management devices, and/or the like. For example, the anomaly detection system may receive VTU data associated with VTUs, and may identify a problematic VTU from the VTU data. The anomaly detection system may extract VTU messages from the VTU data associated with the problematic VTU, and may calculate a faulty event score, a faulty location score, a faulty battery score, a faulty alerts score, a faulty other score, and/or a heartbeat score based on the VTU messages. The anomaly detection system may calculate a faulty VTU score for the problematic VTU based on the faulty event score, the faulty location score, the faulty battery score, the faulty alerts score, the faulty other score, and/or the heartbeat score, and may aggregate the VTU messages into aggregated VTU messages. The anomaly detection system may process the aggregated VTU messages, with an LLM, to determine a problem with the problematic VTU and an explanation of the problem, and may perform actions based on the problem and the explanation.

In this way, the anomaly detection system identifies faulty VTUs. For example, the anomaly detection system may provide real-time identification of faulty VTUs using advanced analytics and language model processing. The anomaly detection system may identify a problematic VTU based on VTU messages associated with the problematic VTU. The anomaly detection system may calculate various scores based on VTU messages associated with the problematic VTU, and may combine the various scores to determine a faulty VTU score, which assists in determining the health of the problematic VTU. The anomaly detection system may aggregate the VTU messages into a condensed format to streamline processing with a large language model (LLM) augmented by a retrieval-augmented generation (RAG) model. The LLM and the RAG model may assess the aggregated VTU messages to determine a problem with the problematic VTU and to provide an explanation for the problem. Based on this assessment, the anomaly detection system may perform one or more targeted actions to address the identified problem. Thus, the anomaly detection system may conserve computing resources, networking resources, and/or other resources that would have otherwise been consumed by failing to accurately identify problematic VTUs in real time, failing to generate alerts for the problematic VTUs, generating incorrect fleet management information based on incorrect information received from the problematic VTUs, failing to provide proper vehicle tracking for vehicles associated with the problematic VTUs, and/or the like.

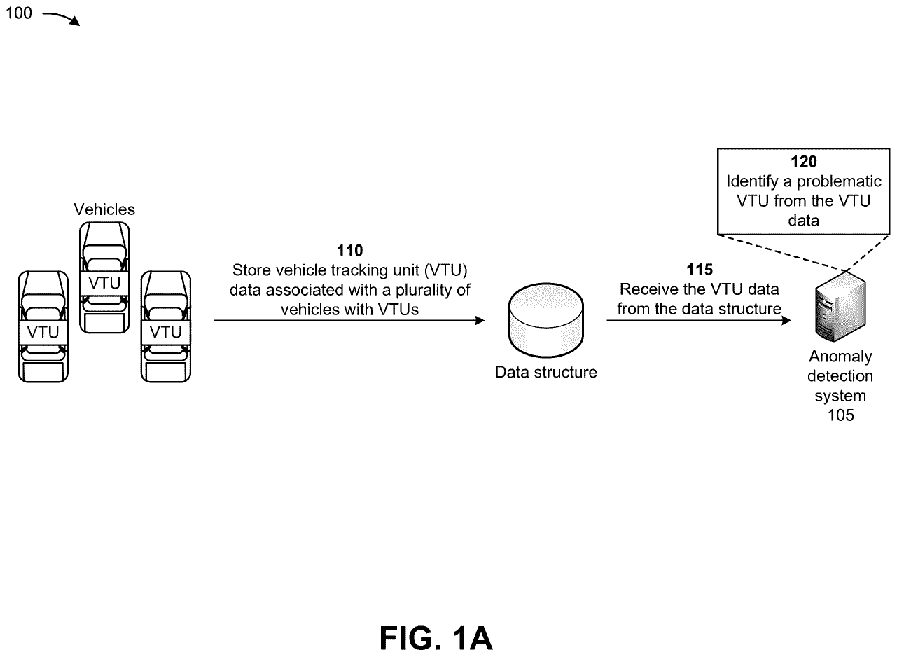

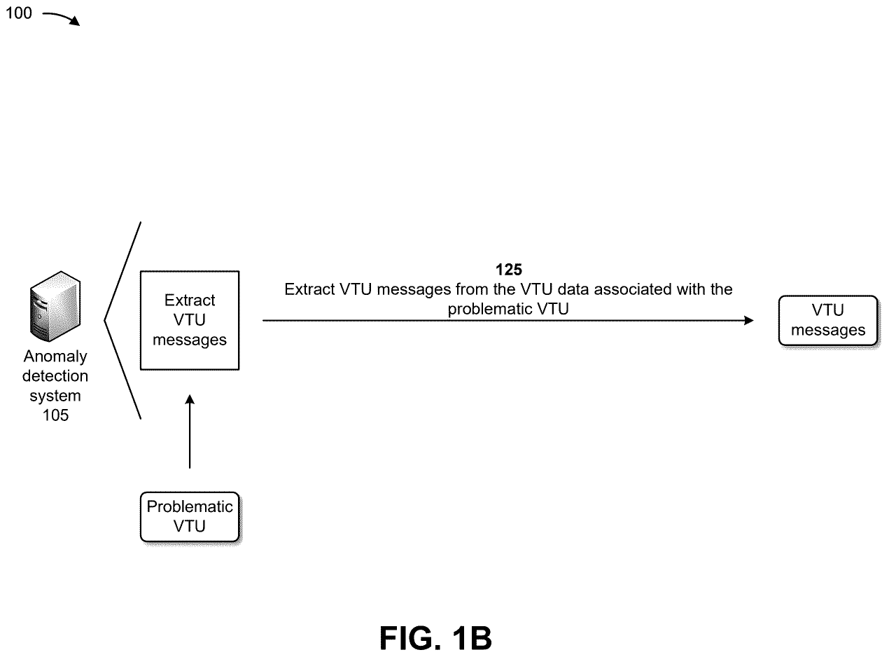

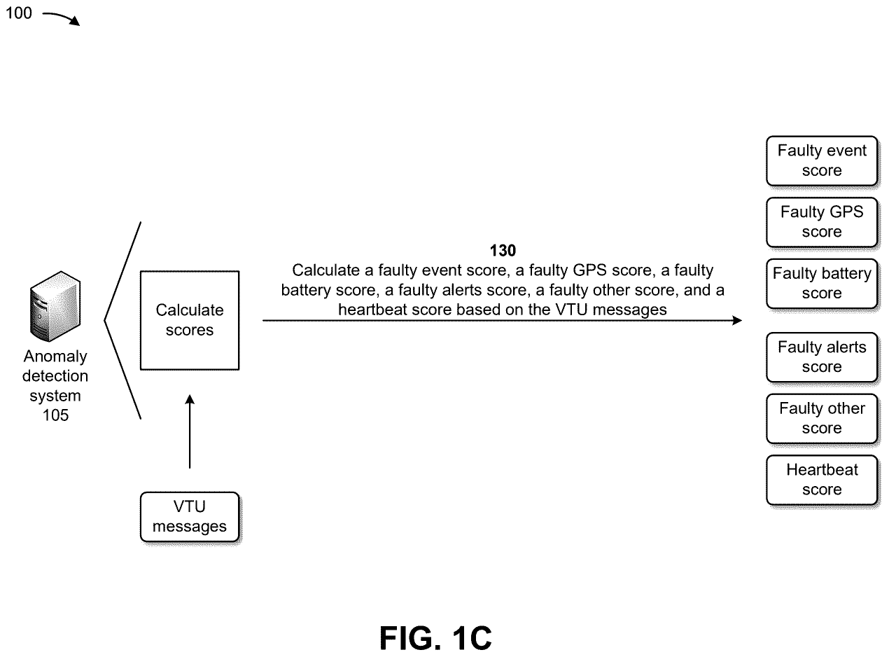

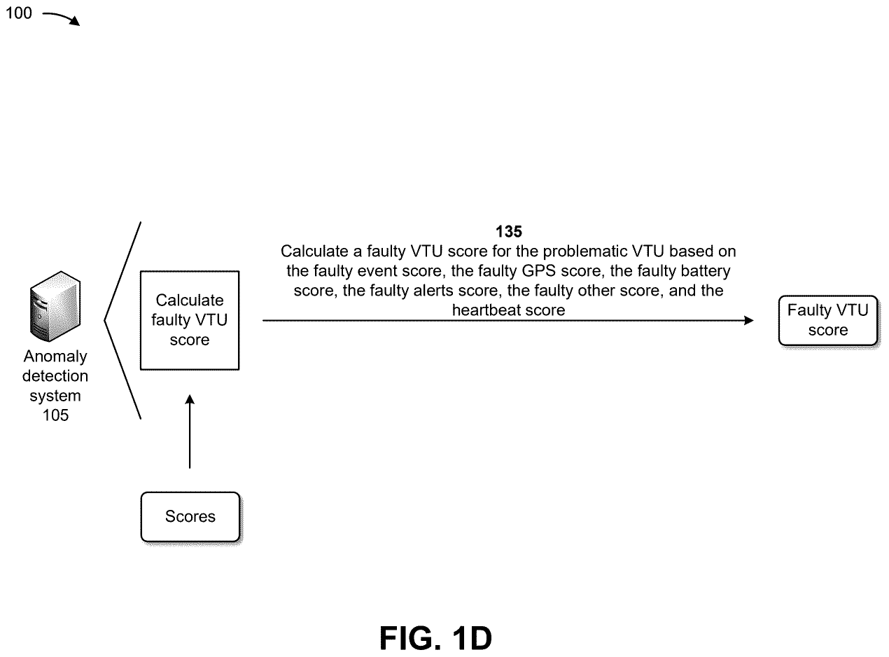

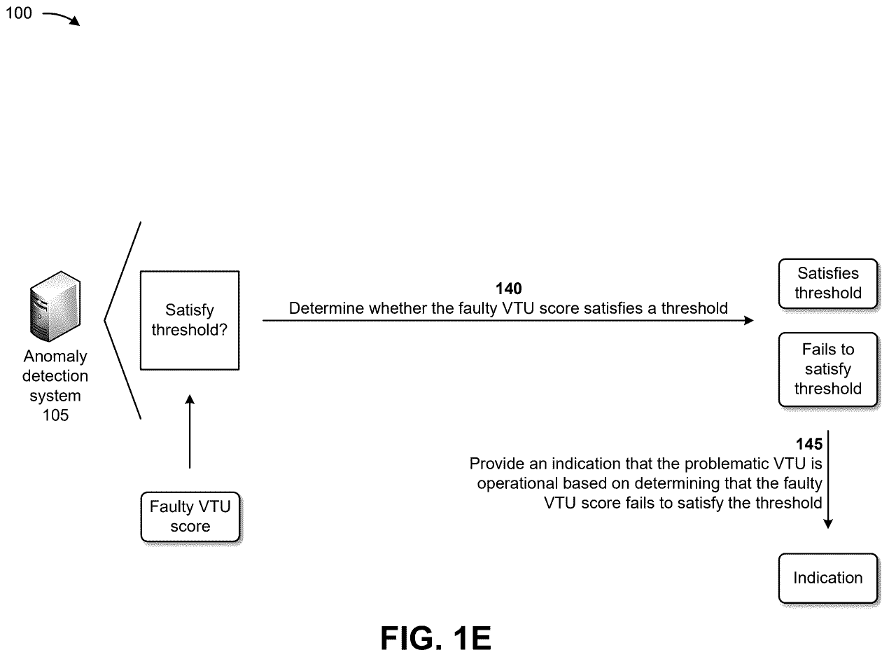

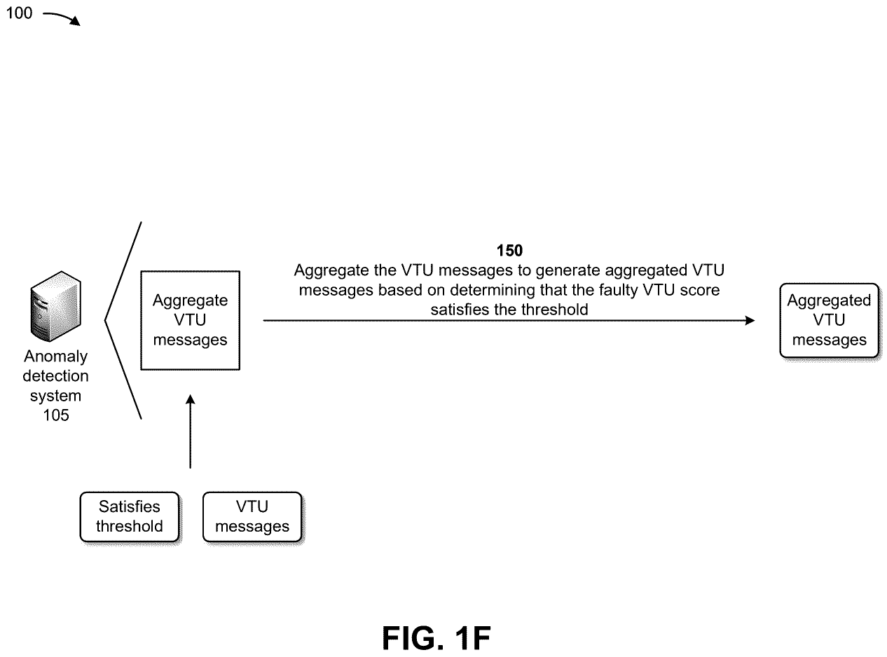

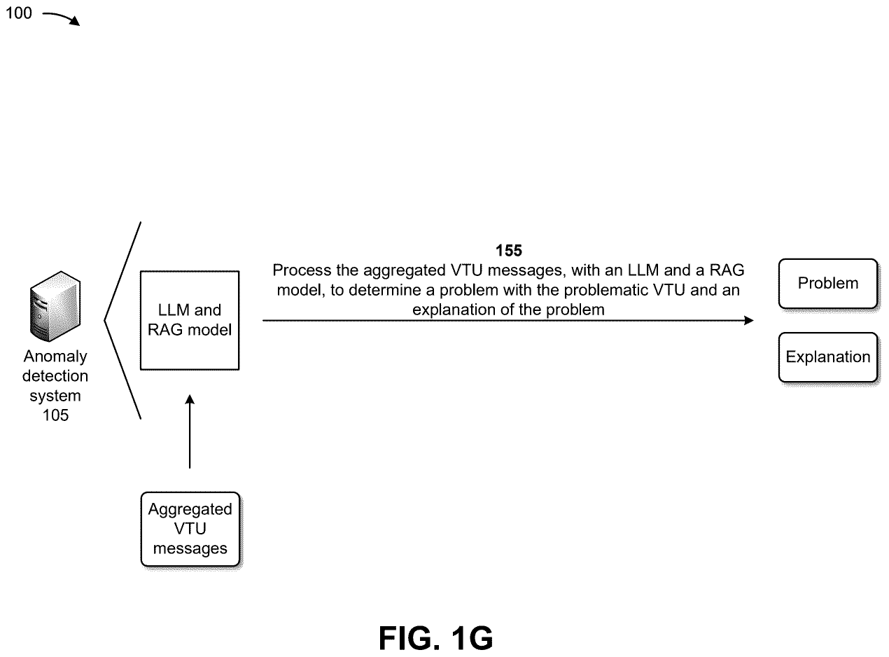

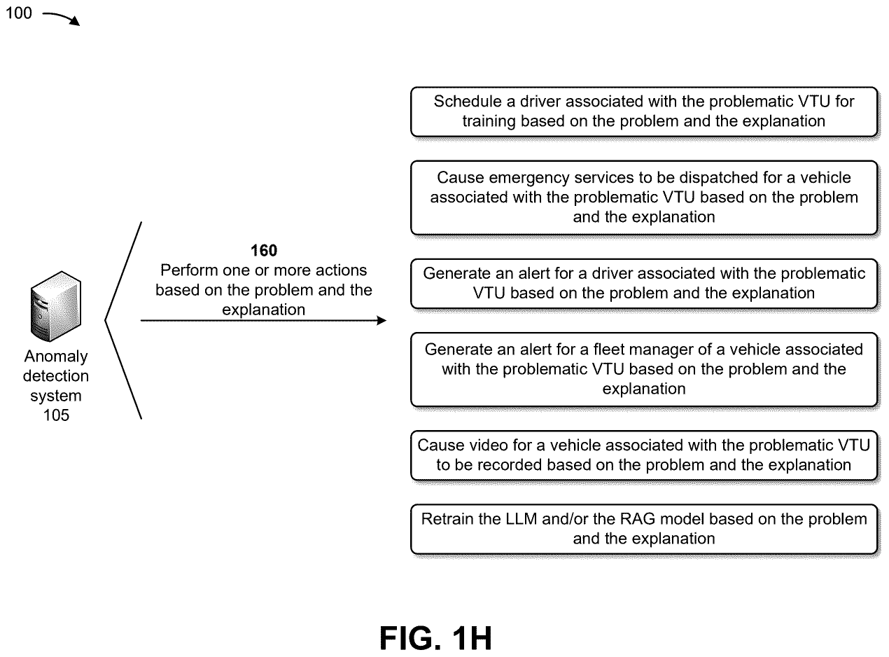

FIGS. 1A-1H are diagrams of an example 100 associated with identifying faulty VTUs. As shown in FIGS. 1A-1H, example 100 includes an anomaly detection system 105 associated with a plurality of vehicles with VTUs. The anomaly detection system 105 may include a system that identifies faulty VTUs. Further details of the anomaly detection system 105, the vehicles, and the VTUs are provided elsewhere herein. Although implementations are described in connection with VTUs, the implementations may be utilized with any device that periodically reports events (e.g., an IoT device, an asset tracking unit, a fleet management device, and/or the like). A VTU is utilized herein as an example of a tracking unit (TU).

As shown in FIG. 1A, and by reference number 110, the VTUs may store, in the data structure, VTU data associated with the plurality of vehicles with the VTUs. For example, the VTUs may be installed in designated vehicles and connected to onboard diagnostic systems of the vehicles. Upon installation, the VTUs may be activated and configured to collect VTU data, such as heartbeat signals, location updates, engine status, alerts, and/or the like associated with the vehicles and VTU conditions. The VTUs may store the VTU data in the data structure. The data structure may receive the VTU data and may generate indexed entries categorized by vehicle identification numbers (VINs), timestamps, and VTU data types. This may provide for efficient retrieval of the VTU data by the anomaly detection system 105 and may support complex queries.

Additionally, or alternatively, the anomaly detection system 105 may include scalability and integration with existing management systems, e.g. vehicle management systems. For example, the anomaly detection system 105 may manage VTU data from thousands of VTUs and may integrate with existing platforms through standardized application programming interfaces (APIs). This may enable seamless data sharing and may enhance fleet management efficiency. Additionally, or alternatively, the anomaly detection system 105 may include security and privacy measures for protecting the VTU data. For example, the anomaly detection system 105 and the data structure may implement encryption protocols for data transmission and storage of the VTU data, may provide access controls for authorized personnel only to the VTU data, and may enforce compliance with regulations for the VTU data.

As further shown in FIG. 1A, and by reference number 115, the anomaly detection system 105 may receive the VTU data from the data structure. For example, the anomaly detection system 105 may continuously receive the VTU data from the data structure, may periodically receive the VTU data from the data structure, may receive the VTU data directly from the VTUs, may receive the VTU data from the data structure or the VTUs based on requesting the VTU data from the data structure or the VTUs, and/or the like. Additionally, or alternatively, receiving the VTU data from the data structure may include the anomaly detection system 105 receiving, from the data structure, real-time or batch updates of the VTU data, which may include vehicle status reports and alert messages. Real-time updates may enable the anomaly detection system 105 to immediately detect anomalies, while batch updates may enable the anomaly detection system 105 to immediately process large data sets.

As further shown in FIG. 1A, and by reference number 120, the anomaly detection system 105 may identify a problematic VTU from the VTU data. For example, the anomaly detection system 105 may analyze the received VTU data to detect anomalies or irregularities that indicate a malfunctioning or problematic VTU, such as missing heartbeat signals or unusual message patterns. In some implementations, identifying a problematic VTU from the VTU data may include the anomaly detection system 105 analyzing the VTU data to flag VTUs exhibiting irregularities, such as inconsistent heartbeat signals. This analysis may include detecting deviations from expected heartbeat signal patterns. Additionally, or alternatively, identifying a problematic VTU from the VTU data may include the anomaly detection system 105 detecting problematic VTUs by identifying anomalies, such as missing data points or erratic location updates. Such anomalies may indicate underlying issues with the VTU or a vehicle associated with the VTU. Additionally, or alternatively, identifying a problematic VTU from the VTU data may include the anomaly detection system 105 identifying faulty VTUs through pattern recognition of unusual data trends or by applying predefined anomaly detection rules. The anomaly detection rules may be based on historical data and/or known fault conditions.

As shown in FIG. 1B, and by reference number 125, the anomaly detection system 105 may extract VTU messages from the VTU data associated with the problematic VTU. For example, the anomaly detection system 105 may analyze the VTU data received from the data structure and may isolate a subset of the VTU data that includes VTU messages pertaining to the problematic VTU. The VTU messages may include heartbeat signals, location updates, engine status reports, alerts, and other relevant data indicative of a condition of the problematic VTU. In some implementations, extracting the VTU messages from the VTU data may include the anomaly detection system 105 filtering and parsing the VTU data to identify and gather VTU specific messages that correspond to identified irregularities in the problematic VTU. This may ensure that the anomaly detection system 105 has precise and relevant data for further processing. Additionally, or alternatively, extracting the VTU messages from the VTU data may include the anomaly detection system 105 parsing the VTU data to isolate VTU messages that indicate irregularities in the problematic VTU.

Additionally, or alternatively, extracting the VTU messages from the VTU data may include the anomaly detection system 105 retrieving VTU messages from the data structure, where the VTU messages are categorized by type, such as location updates, alerts, and engine status reports, and then extracting the VTU messages associated with the problematic VTU. Categorizing messages by type may facilitate an organized extraction process, allowing for quicker identification of relevant data. Additionally, or alternatively, to extract relevant VTU messages from the VTU data, the anomaly detection system 105 may apply specific filtering criteria to the raw VTU data, focusing on signals and reports that reflect abnormal behavior of the problematic VTU. For example, applying filtering criteria may aid in sorting significant irregularities from normal operations, thereby improving anomaly detection accuracy. Additionally, or alternatively, the anomaly detection system 105 may utilize a data parser to sift through the VTU data and isolate VTU messages, such as heartbeat signals and engine status reports, that are useful for diagnosing issues with the problematic VTU.

Additionally, or alternatively, in some implementations, the anomaly detection system 105 may utilize a machine learning model to identify and extract, from the VTU data, VTU messages that are indicative of faulty conditions in the problematic VTU. Utilizing a machine learning model may enhance the capability of the anomaly detection system 105 to detect complex patterns and subtle anomalies. Additionally, or alternatively, the anomaly detection system 105 may retrieve VTU messages from the data structure by executing search queries that target specific types of data, such as location updates and alerts, associated with the problematic VTU.

As shown in FIG. 1C, and by reference number 130, the anomaly detection system 105 may calculate a faulty event score, a faulty GPS score, a faulty battery score, a faulty alerts score, a faulty other score, and a heartbeat score based on the VTU messages. For example, the anomaly detection system 105 may analyze the extracted VTU messages to derive individual scores that quantify different implementations of VTU performance, and may store the scores for future analysis. In some implementations, the faulty event score may indicate a frequency and a severity of anomalous events reported by the problematic VTU. For example, the faulty event score may be determined by evaluating the occurrence of unexpected behaviors such as sudden stops or erratic driving patterns. In some implementations, the anomaly detection system 105 may calculate the faulty event score (S_{FaultyEventTypes}) as follows:

$${S}_{Faulty EventTypes} = {\sum }_{e ∈ E , e \neq HB , T} {( \frac{{M}_{e}}{M} )}^{2} ,$$

where M is a set of received messages for the problematic VTU, one message is m∈M, mₑ is a message of type e∈E, E is a set of possible event types sent by the problematic VTU, and Mₑ⊆M is a subset of events of type e. The faulty event score may be higher if there is no variety in event types that the problematic VTU is sending. For example, the problematic VTU may send a same event several times, indicating some issues. A trip T and heartbeat messages (HB) may be excluded from calculation of the faulty event score. In some implementations, the anomaly detection system 105 may utilize the faulty event score to trigger immediate alerts if the faulty event score exceeds a threshold. For example, if the problematic VTU repeatedly reports critical faults, immediate alerts may notify fleet managers for prompt intervention.

The faulty GPS score may reflect an accuracy and a consistency of location updates provided by the problematic VTU. For example, the anomaly detection system 105 may calculate the faulty GPS score based on metrics, such as trip duration, traveled distance, and location coverage at the end of a trip. In some implementations, the anomaly detection system 105 may calculate the faulty GPS score (S_{FaultyGPS}) for problematic trip messages m_{TP}∈M_{TP}, as follows:

$${S}_{FaultyGPS} = {\sum }_{{m}_{T P} ∈ {M}_{T P}} \frac{{d}_{{M}_{T P} , min}}{{l}_{{M}_{T P} , k m}} \cdot GP S ( {m}_{T P , last lat lon} ) .$$

This score may be high when a trip duration dₘ_{_{TP}}_{,min} does not match a traveled distance lₘ_{_{TP}}_{,km} and a GPS coverage at an end of the trip GPS(m_{TP,last lat lon}) is good. This may indicate that the GPS is not working correctly in the problematic VTU. The GPS coverage may be based on map data (e.g., if last points in the trip indicate entering a tunnel, where coverage is known to be bad or missing, then it is not a problem, as long as a period without coverage is not too long). In some implementations, when calculating the faulty GPS score, the anomaly detection system 105 may cross-reference with external GPS data sources to validate accuracies of location updates of the problematic VTU. For example, discrepancies between recorded locations of the problematic VTU and external GPS sources may highlight potential inaccuracies. Additionally, or alternatively, the anomaly detection system 105 may utilize real-time GPS signal strength and satellite connectivity metrics when calculating the faulty GPS score. This may provide a more immediate and dynamic assessment of the GPS performance of the problematic VTU.

The faulty battery score may represent a health and a reliability of a power supply of the problematic VTU. For example, the faulty battery score may be based on a quantity of VTU messages reporting battery voltage below a predefined threshold. In some implementations, the anomaly detection system 105 may calculate the faulty battery score (S_{FaultyBattery}) as follows:

$${S}_{F a u l t y B a t t e r y} = \frac{1}{\vert {M}_{b a t t - v o l t s} \vert} {\sum }_{m ∈ {M}_{batt - volts}} 1 \cdot ( V ( m ) < {V}_{th} ) .$$

The anomaly detection system 105 may count how many VTU messages have battery voltage values below a specific threshold, normalized by a quantity of battery voltage messages received. M_{batt-volts} may be a subset of all of the VTU messages M reporting battery voltage, V(m) may be a battery voltage reported by a VTU message m, and Vₜₕ may be a device-specific threshold that assures good functioning of the battery of the problematic VTU. In some implementations, when calculating the faulty battery score, the anomaly detection system 105 may consider a rate of battery drain over time. For example, analyzing how quickly the battery voltage drops may inform predictions about battery health. Additionally, or alternatively, the anomaly detection system 105 may utilize the faulty battery score to predict a remaining operational life of the problematic VTU's battery. This may aid in preemptively scheduling maintenance to avoid sudden failures.

The faulty alerts score may assess a severity and a frequency of alert messages generated by the problematic VTU. For example, the faulty alerts score may provide an indication of natures of the alerts, such as critical engine warnings or safety-related notifications. In some implementations, the anomaly detection system 105 may calculate the faulty battery score (S_{FaultyAlerts}) as follows:

$${S}_{FaultyAlerts} = max ( \frac{{\sum }_{M} AlertSeverity ( m )}{\vert M \vert} , {1}_{M} ( A l e r t S e v e r i t y ( m ) = 3 ) ) .$$

An AlertSeverity(m) function of the anomaly detection system 105 may assign a severity score to a VTU message. In one example, the severity score may include a first value (e.g., zero) if the VTU message is not an alert or a warning message, a second value (e.g., one) if the VTU message is a warning message, a third value (e.g., two) if the VTU message is an alert message, and a fourth value (e.g., three) if the VTU message is a critical alert message. The anomaly detection system 105 may calculate a maximum between an average severity of the alert messages present in a sequence and a term that validates a presence of a critical alert message. The term, 1_{M}(x), may represent a function that loops over m∈M and may be one if and only if a condition (x) is true for at least one message (m), otherwise it is zero. This may enforce a minimum value of one for the faulty alerts score in case there is at least one critical alert message. In some implementations, the anomaly detection system 105 may incorporate historical data of similar VTUs to provide a comparative analysis of alert frequencies. This context may highlight anomalies specific to a particular VTU. Additionally, or alternatively, the faulty alerts score may be based on an analysis of time intervals between consecutive alert messages since frequent successive alerts may indicate an escalating issue.

The faulty other score may include other suspicious behaviors or irregularities detected in the operation of the problematic VTU. For example, the faulty other score may be based on patterns of data transmission anomalies or communication failures.

In some implementations, the anomaly detection system 105 may calculate the faulty other score (S_{FaultyOther}) as follows:

$${S}_{F a ultyOther} = \frac{\vert {M}_{u n e x p e c t e d} \vert}{\vert M \vert} .$$

The anomaly detection system 105 may count a quantity of unexpected behaviors (M_{unexpected}) relative to a total quantity of messages M. An unexpected behavior may include device, type, model, and/or configuration dependent specific behavior that is not expected in a sequence of messages. Additionally, or alternatively, calculating the faulty other score may include the anomaly detection system 105 evaluating a frequency of software crashes or restarts experienced by the problematic VTU. This may pinpoint potential software stability issues. Additionally, or alternatively, calculating the faulty other score may include the anomaly detection system 105 performing an analysis of unauthorized access attempts or tampering with the problematic VTU.

In some implementations, the anomaly detection system 105 may group several known suspicious behaviors in the unexpected behaviors. For example, the unexpected behaviors may include receiving more than three engine-on/engine-off concatenated sequences without a movement message in between, receiving an idle on message not followed by shutdown messages, receiving an engine-off message followed by more than one harsh driving event without any movement message in between, receiving more than two consecutive messages of the same type, receiving more than two consecutive position messages after an engine-off message, receiving an engine-on and positions sequence of messages that is not followed by an engine-off message, receiving a sequence that include hard/cold reset messages, receiving a sequence that includes an accelerometer/gyroscope recalibration message, receiving a sequence that includes invalid recorded speed messages, receiving a sequence that includes messages of manual configuration updates, and/or the like.

The heartbeat (HB) score may evaluate a presence and a regularity of heartbeat signals sent by the problematic VTU to confirm operational status. For example, the heartbeat score may be calculated by analyzing a timing and a consistency of heartbeat messages over a specified period. In some implementations, the anomaly detection system 105 may calculate the heartbeat score (S_{HB}) as follows:

$${P}_{H B} = \frac{\vert {M}_{H B} \vert}{\vert M \vert} ,$$

$${\underline{T}}_{HB} = \frac{1}{\vert {M}_{H B} \vert} \cdot {\sum }_{{m}_{H B} ∈ {M}_{H B}} ( {t}_{{m}_{H B}} - {t}_{{m}_{HB} , previous} ) , and$$

$${S}_{HB} = {P}_{Heartbeat} \cdot \frac{{T}_{HB}}{{\underline{T}}_{HB}} .$$

The heartbeat score may be greater when there are a lot of heartbeat messages, (e.g., when a percentage of heartbeat messages P_{HB} is high) and the heartbeat message have a mean period T_{HB} (e.g., an average time between consecutive messages) that is close to or lower than an expected period T_{HB} based on the configuration of the device. Additionally, or alternatively, the anomaly detection system 105 may enhance the heartbeat score based on a signal strength and a quality of a communication channel used by the problematic VTU.

By calculating these individual scores, the anomaly detection system 105 may comprehensively assess a health and a performance of the problematic VTU, contributing to an overall determination of whether the problematic VTU is functioning correctly or experiencing faults. Additionally, or alternatively, the anomaly detection system 105 may aggregate the individual scores into a composite health score for the problematic VTU. Individual scores, such as the faulty event score and the heartbeat score, may be depicted on a dashboard for real-time monitoring. This visualization may aid in quickly identifying and addressing issues. Moreover, the anomaly detection system 105 may apply machine learning models to identify patterns in the individual scores that indicate potential issues.

As shown in FIG. 1D, and by reference number 135, the anomaly detection system 105 may calculate a faulty VTU score for the problematic VTU based on the faulty event score, the faulty GPS score, the faulty battery score, the faulty alerts score, the faulty other score, and the heartbeat score. For example, the anomaly detection system 105 may calculate the faulty VTU score by aggregating the individual scores to assess the overall performance of the VTU. In some implementations, the anomaly detection system 105 may calculate the faulty VTU score by adding the faulty event score, the faulty GPS score, the faulty battery score, the faulty alerts score, and the faulty other score to generate a total score, and subtracting the heartbeat score from the total score to calculate the faulty VTU score for the problematic VTU. The faulty VTU score may provide a comprehensive score that quantifies different implementations of performance of the problematic VTU.

As shown in FIG. 1E, and by reference number 140, the anomaly detection system 105 may determine whether the faulty VTU score satisfies a threshold. For example, the anomaly detection system 105 may compare the faulty VTU score to a predefined threshold value to assess whether the faulty VTU score indicates a problematic VTU. The threshold value may be determined based on historical data and expert-defined rules that distinguish between healthy and faulty VTUs. In some implementations, the anomaly detection system 105 may utilize a machine learning model to dynamically adjust the threshold based on real-time data and evolving patterns in the VTU messages. For example, the machine learning model may analyze incoming data from various VTUs to detect trends and anomalies, thereby optimizing the threshold for each specific situation.

Additionally, or alternatively, determining whether the faulty VTU score satisfies a threshold may include the anomaly detection system 105 utilizing a weighted average of multiple thresholds, each corresponding to different types of scores (e.g., the faulty event score, the faulty battery score, and/or the like) to determine whether the overall faulty VTU score indicates a problematic VTU. This approach may provide for a more nuanced assessment by giving appropriate weight to different implementations of VTU performance, contributing to a more accurate determination. Additionally, or alternatively, determining whether the faulty VTU score satisfies a threshold may include the anomaly detection system 105 applying a range of thresholds depending on a context, such as a type of vehicle, an operational environment, and a recent maintenance history. Different operational conditions may require different thresholds to accurately assess whether a VTU is functioning correctly.

Additionally, or alternatively, determining whether the faulty VTU score satisfies a threshold may include the anomaly detection system 105 incorporating feedback from fleet managers or other personnel to adjust the threshold value over time. This may ensure that the determination of a problematic VTU is continually refined based on practical experience and operational feedback, enhancing the accuracy of the anomaly detection system 105. Additionally, or alternatively, determining whether the faulty VTU score satisfies a threshold may include the anomaly detection system 105 employing a multi-stage evaluation process where the faulty VTU score is first compared to a preliminary threshold, and, if the faulty VTU score is close to this threshold, the anomaly detection system 105 may conduct a further detailed analysis to make a final determination.

As further shown in FIG. 1E, and by reference number 145, the anomaly detection system 105 may provide an indication that the problematic VTU is operational based on determining that the faulty VTU score fails to satisfy the threshold. For example, if the faulty VTU score fails to satisfy the predefined threshold, the anomaly detection system 105 may generate an indication that the VTU is functioning correctly. This indication may be communicated to fleet managers or other relevant personnel, ensuring they are informed about the operational status of the VTU. In some implementations, providing an indication that the problematic VTU is operational may include the anomaly detection system 105 communicating this status not only to fleet managers but also directly to a centralized monitoring dashboard. This may enable the status of the problematic VTU to be visualized alongside other operational metrics.

Additionally, or alternatively, providing an indication that the problematic VTU is operational may include the anomaly detection system 105 logging the status in a data structure for historical analysis and trend monitoring. This may facilitate identification of recurring patterns or potential predictive maintenance opportunities. Additionally, or alternatively, providing an indication that the problematic VTU is operational may include the anomaly detection system 105 generating alerts in various forms, such as emails, text messages, or automated phone calls. Additionally, or alternatively, providing an indication that the problematic VTU is operational may include the anomaly detection system 105 providing a summary report detailing the specific scores that contributed to the determination. Such reports may provide insights into the health and performance of the VTU, helping managers understand the factors driving the assessment. Additionally, or alternatively, providing an indication that the problematic VTU is operational may include the anomaly detection system 105 implementing a tiered notification system, where different levels of alerts are sent depending on the proximity of the faulty VTU score to the threshold.

As shown in FIG. 1F, and by reference number 150, the anomaly detection system 105 may aggregate the VTU messages to generate aggregated VTU messages based on determining that the faulty VTU score satisfies the threshold. For example, if the faulty VTU score satisfies the threshold, the anomaly detection system 105 may determine that there are potential issues with the problematic VTU and may consolidate the VTU messages into a more manageable and interpretable format, referred to as aggregated VTU messages. The anomaly detection system 105 may aggregate the VTU messages to generate the aggregated VTU messages by summarizing non-problematic VTU messages and retaining only problematic VTU messages in original detailed formats to ensure that significant data is preserved while redundant information is minimized. This condensed form of the VTU messages may simplify subsequent analysis and processing, such as by a large language model (LLM) for further diagnostics and problem explanation. For example, problematic VTU messages may include indications of hardware malfunctions or significant deviations from expected behavior, whereas non-problematic VTU messages may include periodic status updates that do not require extensive scrutiny.

In some implementations, the anomaly detection system 105 may categorize the VTU messages into high-priority and low-priority groups, where high-priority messages preserve all relevant details for immediate review and low-priority messages are summarized to highlight trends and minimize unnecessary data storage. In some implementations, the anomaly detection system 105 may pair detailed logs of system errors with summary logs of regular operation to provide a comprehensive yet accessible overview of VTU performance. Additionally, or alternatively, the anomaly detection system 105 may forward critical, detailed logs to diagnostic tools and may provide summary reports of normal operations to storage, optimizing the flow of important information for prompt analysis and resolution.

In some implementations, the anomaly detection system 105 may utilize a set of rules to aggregate the VTU messages and generate the aggregated VTU messages. For example, if a non-problematic trip is detected, a sequence of messages from a beginning of the trip to an end of the trip may be aggregated into one single message (e.g., TIMESTAMP, NORMAL TRIP, MESSAGE_COUNT, TRIP_DURATION, TRAVELLED_DISTANCE, NO ISSUES). If a problematic trip is detected (e.g., the VTU stopped reporting while moving and some alert messages were sent), the trip may be aggregated in the same format (e.g., TIMESTAMP, PROBLEMATIC TRIP, MESSAGE_COUNT, TRIP_DURATION, TRAVELLED_DISTANCE, UNFINISHED TRIP AT (LAT, LON)) but the issues may be reported as a separate message (e.g., TIMESTAMP, PROBLEMATIC TRIP, MESSAGE_COUNT, TRIP_DURATION, TRAVELLED_DISTANCE, LIST_OF_WARNINGS), where the list of warnings is a comma-separated sequence of alerts received. A VTU may send particular messages when not traveling and those messages may be categorized into sequences and aggregated in a format (e.g., TIMESTAMP, IDLING MESSAGES {CAT}, MESSAGE_COUNT, DURATION, TRAVELLED_DISTANCE, ADDITIONAL INFORMATION), where {CAT} is the predefined category of an idling message sequence and ADDITIONAL INFORMATION is an aggregation of relevant information conveyed by the messages. For example, if the VTU sends a sequence of heartbeat messages one after the other, each one carrying the information of the battery voltage, the final message may be TIMESTAMP, IDLING MESSAGES HEARTBEAT, MESSAGE_COUNT, DURATION, TRAVELLED_DISTANCE, BATT_VOLTS. A sequence of messages indicating a shutdown of a VTU after an engine-off may include TIMESTAMP, IDLING MESSAGES VTU MODULE SHUTDOWN, MESSAGE_COUNT, DURATION, TRAVELLED_DISTANCE, ALL GOOD. Problematic or unexpected messages may be kept in original formats, so that most of their information may be retained and only rearranged to be compliant with the aggregated format.

As shown in FIG. 1G, and by reference number 155, the anomaly detection system 105 may process the aggregated VTU messages, with an LLM and a RAG model, to determine a problem with the problematic VTU and an explanation of the problem. For example, the anomaly detection system 105 may utilize the LLM and the RAG model to analyze the aggregated VTU messages and identify patterns or anomalies indicative of a problem. The LLM may generate a detailed explanation of the problem based on the LLM's understanding of the aggregated VTU messages and contextual information retrieved by the RAG model. In some implementations, the RAG model may access internal knowledge bases and configuration data to support the LLM in providing accurate and contextually relevant explanations. For example, the RAG model may retrieve information about firmware versions, known issues, and potential root causes to enhance the LLM's analysis. Additionally, or alternatively, the LLM and the RAG model may collaboratively produce a score indicating a severity of the problem, which may be compared against predefined thresholds to determine a criticality of the problem. In some implementations, the LLM may suggest potential solutions or actions to be taken based on the identified problem and explanation. For example, the LLM may recommend a software update, a hardware replacement, or a configuration adjustment to resolve the problem with the problematic VTU.

In some implementations, the RAG model may provide a base LLM with one or more tools that the LLM may access in order to gain more information. For example, the RAG model may provide the LLM with access to internal Wikis and knowledge bases that include information about each VTU message and a potential corresponding root cause, and may provide access to a management tool of the VTUs that includes current configurations and firmware versions of the VTUs. In some implementations, the LLM may output a normalized faulty score in a range from zero (e.g., healthy) to one (e.g., very problematic) based on the aggregated VTU messages, and may request access to the knowledge base using the RAG to better understand VTU messages reporting issues. The LLM may compare the faulty score to the faulty VTU score and may determine that the VTU has a problem when the faulty score is sufficiently similar to the faulty VTU score. Based on determining the problem, the LLM may provide a human-readable explanation of the problem, such as a description of the problem, side effects that the problem may cause, a likely root cause of the problem, a possible solution to the problem, and/or the like, all tailored by the LLM to the specific VTU being analyzed.

As shown in FIG. 1H, and by reference number 160, the anomaly detection system 105 may perform one or more actions based on the problem and the explanation. In some implementations, performing the one or more actions includes the anomaly detection system 105 scheduling a driver associated with the problematic VTU for training based on the problem and the explanation. For example, if the problem is associated with poor driving by a driver associated with the problematic VTU, the anomaly detection system 105 may schedule the driver for training to address the poor driving by the driver. In this way, the anomaly detection system 105 conserves computing resources, networking resources, and/or other resources that would have otherwise been consumed by generating incorrect fleet management information based on incorrect information received from the problematic VTUs.

In some implementations, performing the one or more actions includes the anomaly detection system 105 causing emergency services to be dispatched for a vehicle associated with the problematic VTU based on the problem and the explanation. For example, the anomaly detection system 105 may determine that the problem is associated with an accident by the vehicle associated with the problematic VTU. The anomaly detection system 105 may contact emergency services and/or the driver of the vehicle so that emergency services may be provided to the vehicle involved in the accident. In this way, the anomaly detection system 105 conserves computing resources, networking resources, and/or other resources that would have otherwise been consumed by failing to provide proper vehicle tracking for vehicles associated with the problematic VTUs.

In some implementations, performing the one or more actions includes the anomaly detection system 105 generating an alert for a driver associated with the problematic VTU based on the problem and the explanation. For example, the anomaly detection system 105 may generate an alert (e.g., audible, visual, tactile, and/or a combination of the aforementioned) that identifies the problem and the explanation, and may provide the alert to a user device or a vehicle of a driver associated with the problematic VTU. The anomaly detection system 105 may provide the alert to the user device or the vehicle, and the user device or the vehicle may provide the alert to the driver. In this way, the anomaly detection system 105 conserves computing resources, networking resources, and/or other resources that would have otherwise been consumed by failing to generate alerts for the problematic VTUs.

In some implementations, performing the one or more actions includes the anomaly detection system 105 generating an alert for a fleet manager of a vehicle associated with the problematic VTU based on the problem and the explanation. For example, the anomaly detection system 105 may generate an alert (e.g., audible, visual, tactile, and/or a combination of the aforementioned) that identifies the problem and the explanation, and may provide the alert to a user device of a fleet manager associated with the problematic VTU. The anomaly detection system 105 may provide the alert to the user device, and the user device may provide the alert to the fleet manager. In this way, the anomaly detection system 105 conserves computing resources, networking resources, and/or other resources that would have otherwise been consumed by failing to generate alerts for the problematic VTUs.

In some implementations, performing the one or more actions includes the anomaly detection system 105 causing video for a vehicle associated with the problematic VTU to be recorded based on the problem and the explanation. For example, the vehicle associated with the problematic VTU may include a video recording device. The anomaly detection system 105 may determine that the problem and explanation warrant further investigation of operation of the vehicle. Thus, the anomaly detection system 105 may instruct the video recording device to record video of operation of the vehicle so that a fleet manager may review the video and take appropriate measures. In this way, the anomaly detection system 105 conserves computing resources, networking resources, and/or other resources that would have otherwise been consumed by generating incorrect fleet management information based on incorrect information received from the problematic VTUs.

In some implementations, performing the one or more actions includes the anomaly detection system 105 retraining the LLM and/or the RAG model based on the problem and the explanation. For example, the anomaly detection system 105 may utilize the problem and the explanation as additional training data for retraining the LLM and/or the RAG model, thereby increasing the quantity of training data available for training the LLM and/or the RAG model. Accordingly, the anomaly detection system 105 may conserve computing resources associated with failing to accurately identify problematic VTUs in real time, failing to generate alerts for the problematic VTUs, generating incorrect fleet management information based on incorrect information received from the problematic VTUs, failing to provide proper vehicle tracking for vehicles associated with the problematic VTUs, and/or the like.

In this way, the anomaly detection system 105 identifies faulty VTUs. For example, the anomaly detection system 105 may provide real-time identification of faulty VTUs using advanced analytics and language model processing. The anomaly detection system 105 may identify a problematic VTU based on VTU messages associated with the problematic VTU. The anomaly detection system 105 may calculate various scores based on VTU messages associated with the problematic VTU, and may combine the various scores to determine a faulty VTU score, which assists in determining the health of the problematic VTU. The anomaly detection system 105 may aggregate the VTU messages into a condensed format to streamline processing with an LLM augmented by a RAG model. The LLM and the RAG model may assess the aggregated VTU messages to determine a problem with the problematic VTU and to provide an explanation for the problem. Based on this assessment, the anomaly detection system 105 may perform one or more targeted actions to address the identified problem. Thus, the anomaly detection system 105 may conserve computing resources, networking resources, and/or other resources that would have otherwise been consumed by failing to accurately identify problematic VTUs in real time, failing to generate alerts for the problematic VTUs, generating incorrect fleet management information based on incorrect information received from the problematic VTUs, failing to provide proper vehicle tracking for vehicles associated with the problematic VTUs, and/or the like.

As indicated above, FIGS. 1A-1H are provided as an example. Other examples may differ from what is described with regard to FIGS. 1A-1H. The number and arrangement of devices shown in FIGS. 1A-1H are provided as an example. In practice, there may be additional devices, fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

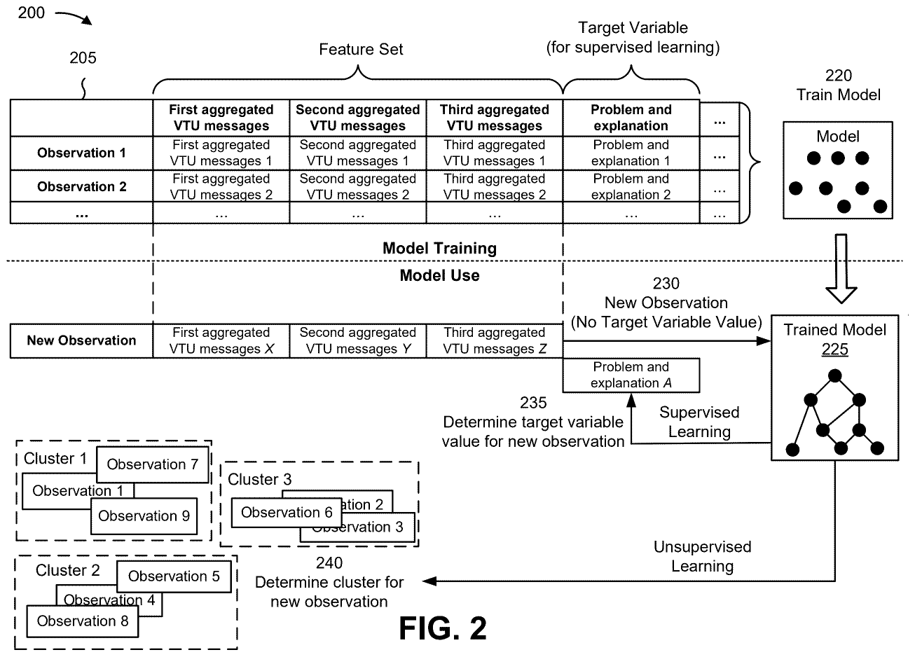

FIG. 2 is a diagram illustrating an example 200 of training and using a machine learning model. The machine learning model training and usage described herein may be performed using a machine learning system. The machine learning system may include or may be included in a computing device, a server, a cloud computing environment, or the like, such as the anomaly detection system 105.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the anomaly detection system 105, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the anomaly detection system 105. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of first aggregated VTU messages, a second feature of second aggregated VTU messages, a third feature of third aggregated VTU messages, and so on. As shown, for a first observation, the first feature may have a value of first aggregated VTU messages 1, the second feature may have a value of second aggregated VTU messages 1, the third feature may have a value of third aggregated VTU messages 1, and so on. These features and feature values are provided as examples, and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is a problem and explanation, which has a value of problem and explanation 1 for the first observation. The feature set and target variable described above are provided as examples, and other examples may differ from what is described above.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of first aggregated VTU messages X, a second feature of second aggregated VTU messages Y, a third feature of third aggregated VTU messages Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of problem and explanation A for the target variable of problem and explanation for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a first aggregated VTU messages cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a second aggregated VTU messages cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model).

In this way, the machine learning system may apply a rigorous and automated process to identify faulty VTUs. The machine learning system may enable recognition and/or identification of tens, hundreds, thousands, or millions of features and/or feature values for tens, hundreds, thousands, or millions of observations, thereby increasing accuracy and consistency and reducing delay associated with identifying faulty VTUs relative to requiring computing resources to be allocated for tens, hundreds, or thousands of operators to manually identify faulty VTUs.

As indicated above, FIG. 2 is provided as an example. Other examples may differ from what is described in connection with FIG. 2.

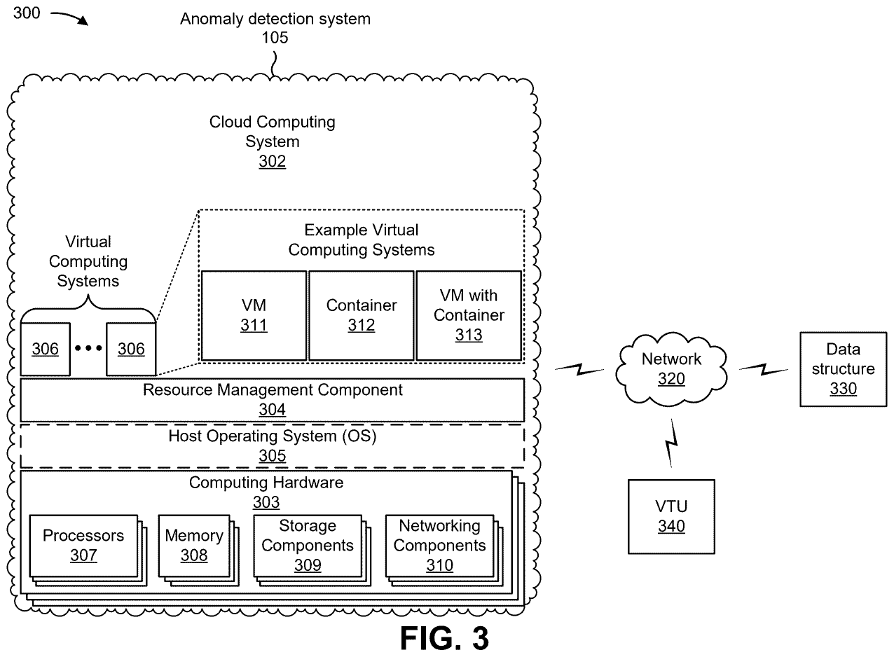

FIG. 3 is a diagram of an example environment 300 in which systems and/or methods described herein may be implemented. As shown in FIG. 3, the environment 300 may include the anomaly detection system 105, which may include one or more elements of and/or may execute within a cloud computing system 302. The cloud computing system 302 may include one or more elements 303-313, as described in more detail below. As further shown in FIG. 3, the environment 300 may include a network 320, a data structure 330, and a VTU 340. Devices and/or elements of the environment 300 may interconnect via wired connections and/or wireless connections.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

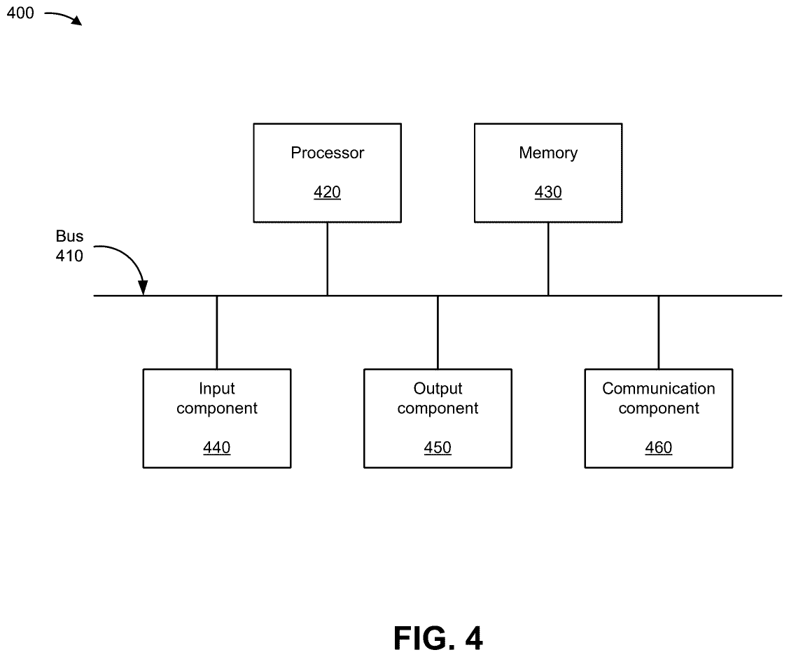

Although the anomaly detection system 105 may include one or more elements 303-313 of the cloud computing system 302, may execute within the cloud computing system 302, and/or may be hosted within the cloud computing system 302, in some implementations, the anomaly detection system 105 may not be cloud-based (e.g., may be implemented outside of a cloud computing system) or may be partially cloud-based. For example, the anomaly detection system 105 may include one or more devices that are not part of the cloud computing system 302, such as a device 400 of FIG. 4, which may include a standalone server or another type of computing device. The anomaly detection system 105 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The data structure 330 may include one or more devices capable of receiving, generating, storing, processing, and/or providing information, as described elsewhere herein. The data structure 330 may include a communication device and/or a computing device. For example, the data structure 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 330 may communicate with one or more other devices of environment 300, as described elsewhere herein.

The VTU 340 may include one or more devices capable of receiving, generating, storing, processing, and/or providing information, as described elsewhere herein. The VTU 340 may include a communication device and/or a computing device. For example, the VTU 340 may include a navigation device within an object (e.g., a vehicle, an asset, a person, an animal, and/or the like) that utilizes satellite navigation to determine object movement and geographic position for identifying a location of the object. The VTU 340 may include a global positioning system (GPS) tracking unit, a geotracking unit, a satellite tracking unit, a wireless communication device, a mobile phone, a user equipment (UE), a laptop computer, a tablet computer, a wearable communication device (e.g., a smart wristwatch, a pair of smart eyeglasses, a head mounted display, or a virtual reality headset), an IoT device, or a similar type of device.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the anomaly detection system 105, the data structure 330, and/or the VTU 340. In some implementations, the anomaly detection system 105, the data structure 330, and/or the VTU 340 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

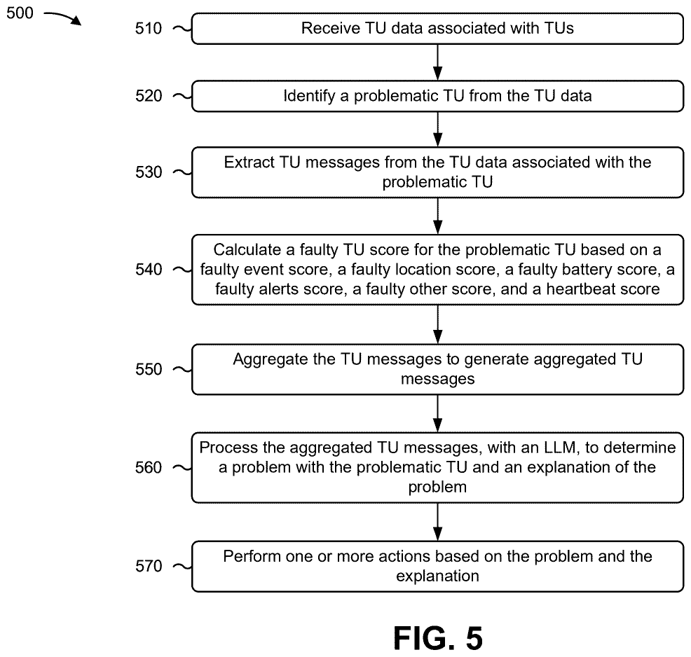

FIG. 5 depicts a flowchart of an example process 500 for identifying faulty TUs. In some implementations, one or more process blocks of FIG. 5 may be performed by a device (e.g., the anomaly detection system 105). In some implementations, one or more process blocks of FIG. 5 may be performed by another device or a group of devices separate from or including the device. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving TU data associated with TUs (block 510). For example, the device may receive TU data associated with TUs, as described above. In some implementations, receiving the TU data associated with the TUs includes retrieving the TU data from a data structure associated with the device.

As further shown in FIG. 5, process 500 may include identifying a problematic TU from the TU data (block 520). For example, the device may identify a problematic TU from the TU data, as described above. In some implementations, identifying the problematic TU from the TU data includes applying rules that vary based on TU type, TU model, and TU configuration to identify the problematic TU.

As further shown in FIG. 5, process 500 may include extracting TU messages from the TU data associated with the problematic TU (block 530). For example, the device may extract TU messages from the TU data associated with the problematic TU, as described above.

As further shown in FIG. 5, process 500 may include calculating a faulty TU score for the problematic TU based on a faulty event score, a faulty location score, a faulty battery score, a faulty alerts score, a faulty other score, and a heartbeat score (block 540). For example, the device may calculate a faulty event score, a faulty location score, a faulty battery score, a faulty alerts score, a faulty other score, and a heartbeat score based on the TU messages, as described above. In some implementations, calculating the faulty location score, the faulty battery score, the faulty alerts score, and the faulty other score includes calculating the faulty location score based on a trip duration, a traveled distance, and location coverage at an end of a trip, calculating the faulty battery score based on a quantity of the TU messages reporting battery voltage below a predefined threshold, calculating the faulty alerts score based on severities of alert messages received from the problematic TU, and calculating the faulty other score based on one or more suspicious behaviors of the problematic TU. In some implementations, the device may calculate a faulty TU score for the problematic TU based on the faulty event score, the faulty location score, the faulty battery score, the faulty alerts score, the faulty other score, and the heartbeat score, as described above. In some implementations, calculating the faulty TU score for the problematic TU includes adding the faulty event score, the faulty location score, the faulty battery score, the faulty alerts score, and the faulty other score to generate a total score, and subtracting the heartbeat score from the total score to calculate the faulty TU score.

As further shown in FIG. 5, process 500 may include aggregating the TU messages to generate aggregated TU messages (block 550). For example, the device may aggregate the TU messages to generate aggregated TU messages, as described above. In some implementations, aggregating the TU messages to generate the aggregated TU messages includes aggregating the TU messages into a condensed format based on a set of rules, wherein the condensed format TU messages correspond to the aggregated TU messages. In some implementations, the condensed format is generated by aggregating non-problematic TU messages and retaining problematic TU messages in original formats.

As further shown in FIG. 5, process 500 may include processing the aggregated TU messages, with an LLM, to determine a problem with the problematic TU and an explanation of the problem (block 560). For example, the device may process the aggregated TU messages, with an LLM, to determine a problem with the problematic TU and an explanation of the problem, as described above. In some implementations, processing the aggregated TU messages, with the LLM, to determine the problem with the problematic TU and the explanation of the problem includes processing the aggregated TU messages, with the LLM and a RAG model, to determine the problem with the problematic TU and the explanation of the problem, wherein the RAG model improves an understanding of the aggregated TU messages by the LLM relative to an understanding of the LLM alone.

As further shown in FIG. 5, process 500 may include performing one or more actions based on the problem and the explanation (block 570). For example, the device may perform one or more actions based on the problem and the explanation, as described above. In some implementations, performing the one or more actions includes providing an alert identifying the problem, the explanation, and one or more potential solutions to the problem. In some implementations, performing the one or more actions includes one or more of scheduling a driver associated with the problematic TU for training based on the problem and the explanation, causing emergency services to be dispatched for a vehicle associated with the problematic TU based on the problem and the explanation, or generating an alert for a driver associated with the problematic TU based on the problem and the explanation. In some implementations, performing the one or more actions includes one or more of generating an alert for a fleet manager of a vehicle associated with the problematic TU based on the problem and the explanation, causing video for a vehicle associated with the problematic TU to be recorded based on the problem and the explanation, or retraining the large language model based on the problem and the explanation.

In some implementations, process 500 includes determining whether the faulty TU score satisfies a threshold, and selectively providing an indication that the problematic TU is operational based on determining that the faulty TU score fails to satisfy the threshold, or generating the aggregated TU messages based on determining that the faulty TU score satisfies the threshold. In some implementations, process 500 includes utilizing the LLM to validate the faulty TU score.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, tracking unit (TU) data associated with TUs;
identifying, by the device, a problematic TU from the TU data;
extracting, by the device, TU messages from the TU data associated with the problematic TU;
calculating, by the device, a faulty event score, a faulty location score, a faulty battery score, a faulty alerts score, a faulty other score, and a heartbeat score based on the TU messages;
calculating, by the device, a faulty TU score for the problematic TU based on the faulty event score, the faulty location score, the faulty battery score, the faulty alerts score, the faulty other score, and the heartbeat score;
aggregating, by the device, the TU messages to generate aggregated TU messages;
processing, by the device, the aggregated TU messages, with a large language model, to determine a problem with the problematic TU and an explanation of the problem; and
performing, by the device, one or more actions based on the problem and the explanation.

2. The method of claim 1, further comprising:
determining whether the faulty TU score satisfies a threshold; and
selectively:
providing an indication that the problematic TU is operational based on determining that the faulty TU score fails to satisfy the threshold, or
generating the aggregated TU messages based on determining that the faulty TU score satisfies the threshold.

3. The method of claim 1, wherein calculating the faulty location score, the faulty battery score, the faulty alerts score, and the faulty other score comprises:
calculating the faulty location score based on a trip duration, a traveled distance, and location coverage at an end of a trip;
calculating the faulty battery score based on a quantity of the TU messages reporting battery voltage below a predefined threshold;
calculating the faulty alerts score based on severities of alert messages received from the problematic TU; and
calculating the faulty other score based on one or more suspicious behaviors of the problematic TU.

4. The method of claim 1, wherein performing the one or more actions comprises:
providing an alert identifying the problem, the explanation, and one or more potential solutions to the problem.

5. The method of claim 1, wherein aggregating the TU messages to generate the aggregated TU messages comprises:
aggregating the TU messages into a condensed format based on a set of rules, wherein the condensed format TU messages correspond to the aggregated TU messages.

6. The method of claim 5, wherein the condensed format is generated by aggregating non-problematic TU messages and retaining problematic TU messages in original formats.

7. The method of claim 1, wherein processing the aggregated TU messages, with the large language model, to determine the problem with the problematic TU and the explanation of the problem, comprises:
processing the aggregated TU messages, with the large language model and a retrieval-augmented generation model, to determine the problem with the problematic TU and the explanation of the problem,
wherein the retrieval-augmented generation model improves an understanding of the aggregated TU messages by the large language model relative to an understanding of the large language model alone.

8. A device, comprising:
one or more processors configured to:
receive tracking unit (TU) data associated with TUs;
identify a problematic TU from the TU data;
extract TU messages from the TU data associated with the problematic TU;
calculate a faulty event score, a faulty location score, a faulty battery score, a faulty alerts score, a faulty other score, and a heartbeat score based on the TU messages;
calculate a faulty TU score for the problematic TU based on the faulty event score, the faulty location score, the faulty battery score, the faulty alerts score, the faulty other score, and the heartbeat score;
determine that the faulty TU score satisfies a threshold;
aggregate the TU messages to generate aggregated TU messages based on determining that the faulty TU score satisfies the threshold;
process the aggregated TU messages, with a large language model, to determine a problem with the problematic TU and an explanation of the problem; and
perform one or more actions based on the problem and the explanation.

9. The device of claim 8, wherein the one or more processors, to perform the one or more actions, are configured to one or more of:
schedule a driver associated with the problematic TU for training based on the problem and the explanation;
cause emergency services to be dispatched for a vehicle associated with the problematic TU based on the problem and the explanation; or
generate an alert for a driver associated with the problematic TU based on the problem and the explanation.

10. The device of claim 8, wherein the one or more processors, to perform the one or more actions, are configured to one or more of:
generate an alert for a fleet manager of a vehicle associated with the problematic TU based on the problem and the explanation;
cause video for a vehicle associated with the problematic TU to be recorded based on the problem and the explanation; or
retrain the large language model based on the problem and the explanation.

11. The device of claim 8, wherein the one or more processors, to receive the TU data associated with the TUs, are configured to:
retrieve the TU data from a data structure associated with the device.

12. The device of claim 8, wherein the one or more processors, to calculate the faulty TU score for the problematic TU, are configured to:
add the faulty event score, the faulty location score, the faulty battery score, the faulty alerts score, and the faulty other score to generate a total score; and
subtract the heartbeat score from the total score to calculate the faulty TU score.

13. The device of claim 8, wherein the one or more processors are further configured to:
utilize the large language model to validate the faulty TU score.

14. The device of claim 8, wherein the one or more processors, to identify the problematic TU from the TU data, are configured to:
apply rules that vary based on TU type, TU model, and TU configuration to identify the problematic TU.

15. A non-transitory computer-readable medium storing a set of instructions, the set of instructions comprising:
one or more instructions that, when executed by one or more processors of a device, cause the device to:
receive tracking unit (TU) data associated with TUs;
identify a problematic TU from the TU data;
extract TU messages from the TU data associated with the problematic TU;
calculate a faulty event score, a faulty location score, a faulty battery score, a faulty alerts score, a faulty other score, and a heartbeat score based on the TU messages;
calculate a faulty TU score for the problematic TU based on the faulty event score, the faulty location score, the faulty battery score, the faulty alerts score, the faulty other score, and the heartbeat score;
aggregate the TU messages to generate aggregated TU messages;
process the aggregated TU messages, with a large language model, to determine a problem with the problematic TU and an explanation of the problem;
utilize the large language model to validate the faulty TU score; and
perform one or more actions based on the problem and the explanation.

16. The non-transitory computer-readable medium of claim 15, wherein the one or more instructions, that cause the device to calculate the faulty location score, the faulty battery score, the faulty alerts score, and the faulty other score, cause the device to:
calculate the faulty location score based on a trip duration, a traveled distance, and location coverage at an end of a trip;
calculate the faulty battery score based on a quantity of the TU messages reporting battery voltage below a predefined threshold;
calculate the faulty alerts score based on severities of alert messages received from the problematic TU; and
calculate the faulty other score based on one or more suspicious behaviors of the problematic TU.

17. The non-transitory computer-readable medium of claim 15, wherein the one or more instructions, that cause the device to aggregate the TU messages to generate the aggregated TU messages, cause the device to:
aggregate the TU messages into a condensed format based on a set of rules,
wherein the condensed format TU messages correspond to the aggregated TU messages, and the condensed format is generated by aggregating non-problematic TU messages and retaining problematic TU messages in original formats.

18. The non-transitory computer-readable medium of claim 15, wherein the one or more instructions, that cause the device to process the aggregated TU messages, with the large language model, to determine the problem with the problematic TU and the explanation of the problem, cause the device to:
process the aggregated TU messages, with the large language model and a retrieval-augmented generation model, to determine the problem with the problematic TU and the explanation of the problem,
wherein the retrieval-augmented generation model improves an understanding of the aggregated TU messages by the large language model relative to an understanding of the large language model alone.

19. The non-transitory computer-readable medium of claim 15, wherein the one or more instructions, that cause the device to calculate the faulty TU score for the problematic TU, cause the device to:
add the faulty event score, the faulty location score, the faulty battery score, the faulty alerts score, and the faulty other score to generate a total score; and
subtract the heartbeat score from the total score to calculate the faulty TU score.

20. The non-transitory computer-readable medium of claim 15, wherein the one or more instructions, that cause the device to identify the problematic TU from the TU data, cause the device to:
apply rules that vary based on TU type, TU model, and TU configuration to identify the problematic TU.
